(19) United States
(12) Patent Application Publication
(10) Pub. No.: US 2013/0064489 A1
(43) Pub. Date: Mar. 14, 2013

(54) AXIAL THRUST BEARING DEVICE WITH A SEALING RING

(71) Applicants: Richard Corbett, Fondettes (FR); Samuel Viault, Saint Antoine Du Rocher (FR)

(72) Inventors: Richard Corbett, Fondettes (FR); Samuel Viault, Saint Antoine Du Rocher (FR)

(21) Appl. No.: 13/638,380

(22) PCT Filed: Mar. 30, 2010
(86) PCT No.: PCT/EP10/54229

§ 371 Date: Nov. 30, 2012

(51) Int. Cl. F16C 19/00; B60G 99/00

(52) U.S. Cl. CPC F16C 19/00; B60G 99/00
USPC 384/607

(57) ABSTRACT

The axial thrust bearing device, in particular for the suspension strut of a motor vehicle, comprises a bottom support cover 18, a top bearing cover 16, a rolling bearing 20 axially disposed between said covers, and at least a sealing ring 22 freely movable in axial direction relative to the bottom support cover and to the support bearing cover. Said sealing ring is adapted to reduce any ingress of foreign matter between said covers.

The sealing ring comprises at least one friction lip 22b, 22c bearing against the bottom support cover 18 and delimits with the top bearing cover 16 at least a labyrinth sealing zone.

The present invention relates to the field of axial thrust bearing devices, used in particular on motor vehicles in the suspension struts of the steered road wheels.

A suspension thrust bearing device is usually provided with a rolling bearing comprising a top ring and a bottom ring between which are positioned rolling elements, for example balls or rollers, and with bottom and top bearing or support pieces, such as covers or cups. The top and bottom covers form a housing for the rings of the rolling bearing and provide the interface between said rings and the neighboring elements.

A suspension thrust bearing device is positioned in the top part of the suspension strut between the bodywork of the vehicle and a suspension spring. The spring is fitted around a damping piston rod, the end of which is linked to the bodywork of the vehicle through an elastic block that filters the vibrations. The suspension spring axially bears, directly or indirectly, on the bottom cover. The top cover is fixed relative to the bodywork of the vehicle.

The rolling bearing makes it possible to transmit axial forces between the suspension spring and the bodywork of the vehicle, while allowing a rotation movement between the bottom cover and the filtering elastic block. This relative angular movement derives from a steer angle of the steered road wheels of the vehicle and/or the compression of the suspension spring.

The French patent application FR-A1-2 918 138 discloses such a suspension thrust bearing device comprising a bottom support cover, a top bearing cover and a rolling bearing axially disposed between said covers. To limit the intrusion of water, dust and other foreign matter between said covers, the device further comprises sealing rings mounted into radial grooves of the bottom support cover and coming into friction contact with external and internal skirts of the top bearing cover.

With such a device, if the bottom support cover is deformed under the effect of the axial loads of the suspension spring, an axial gap may occur between the top bearing cover and one of the sealing rings.

The European patent application EP-A1-1 870 265 also discloses a suspension thrust bearing device comprising a bottom support cover, a top bearing cover, a rolling bearing and sealing rings axially disposed between said covers. The sealing rings are moveable both axially and radially between the covers.

In this document, due to the design of the seals and to their disposition relative to the bottom and top covers, the sealing obtained between said covers may be insufficient in some operating conditions and foreign matter may reach the rolling bearing.

One aim of the present invention is therefore to overcome the aforementioned drawbacks.

It is a particular object of the present invention to provide an axial suspension thrust bearing device which is simple to manufacture and to assembly, economic, while guaranteeing good sealing properties.

It is another object of the present invention to provide an axial thrust bearing device adapted to ensure an effective sealing while limiting in operation the dissipation of energy.

In one embodiment, the axial thrust bearing device, in particular for the suspension strut of a motor vehicle, comprises a bottom support cover, a top bearing cover, and a rolling bearing axially disposed between said covers. The device further comprises at least a sealing ring which is freely movable in axial direction relative to the bottom support cover and to the support bearing cover. Said ring is adapted to reduce any ingress of foreign matter between said covers. The sealing ring comprises at least a friction lip bearing against the bottom support cover. Said sealing ring delimits with the top bearing cover at least a labyrinth sealing zone.

With a sealing ring freely movable in axial direction relative to the bottom support cover and comprising at least a friction lip in contact with said cover, the friction contact between these two elements is limited while guaranteeing the maintain of the sealing even with deformations of the bottom support cover under the effects of the axial loads of the suspension spring. Besides, with the labyrinth sealing zone(s) between the sealing ring and the top bearing cover, the dissipation of energy is also limited.

Advantageously, the sealing ring delimits with the top bearing cover an annular radial labyrinth sealing zone.

An axial portion of the sealing ring from which is issued the friction lip may delimit together with a skirt of the top bearing cover the annular radial labyrinth sealing zone.

In one embodiment, an additional labyrinth sealing zone extending the radial labyrinth sealing zone is delimited between the sealing ring and the top bearing cover. Advantageously, the radial labyrinth sealing zone and the additional sealing zone extend along two different directions. The friction lip of the sealing ring may delimit together with the skirt of the top bearing cover the additional labyrinth sealing zone.

Advantageously, the sealing ring is resting axially on the bottom support cover.

The rolling bearing may comprise a bottom ring in contact with the bottom support cover, a top ring in contact with the top bearing cover and at least one row of rolling elements mounted between the rings.

In a preferred embodiment, the sealing ring is radially disposed between the bottom support cover and the top bearing cover.

In one embodiment, an external skirt of the top bearing cover delimits with the sealing ring the labyrinth sealing zone. Alternatively, an internal skirt of the top bearing cover may delimit with said ring the labyrinth sealing zone.

In a preferred embodiment, the friction lip of the sealing ring bears against a radial surface of the bottom support cover.

Preferentially, the thickness of the tip of the friction lip is smaller than the one of an axial portion from which is issued said friction lip. The friction lip may have in cross-section a triangular shape.

In one embodiment, the sealing ring comprises at least two frictions lips delimiting an annular chamber. The chamber may be filled with lubricant.

Preferentially, the sealing ring is freely movable in radial direction relative to the bottom support cover and to the top bearing cover.

Advantageously, the sealing ring is made in one part. The sealing ring may be made from plastic material or from metal.

According to another aspect, it is proposed a suspension strut for a motor vehicle comprising a damper and an axial thrust bearing device as previously defined.

The present invention and its advantages will be more readily understood by studying the detailed description of specific embodiments, which constitute non-limiting examples of the present invention, and illustrated by the appended drawings on which:

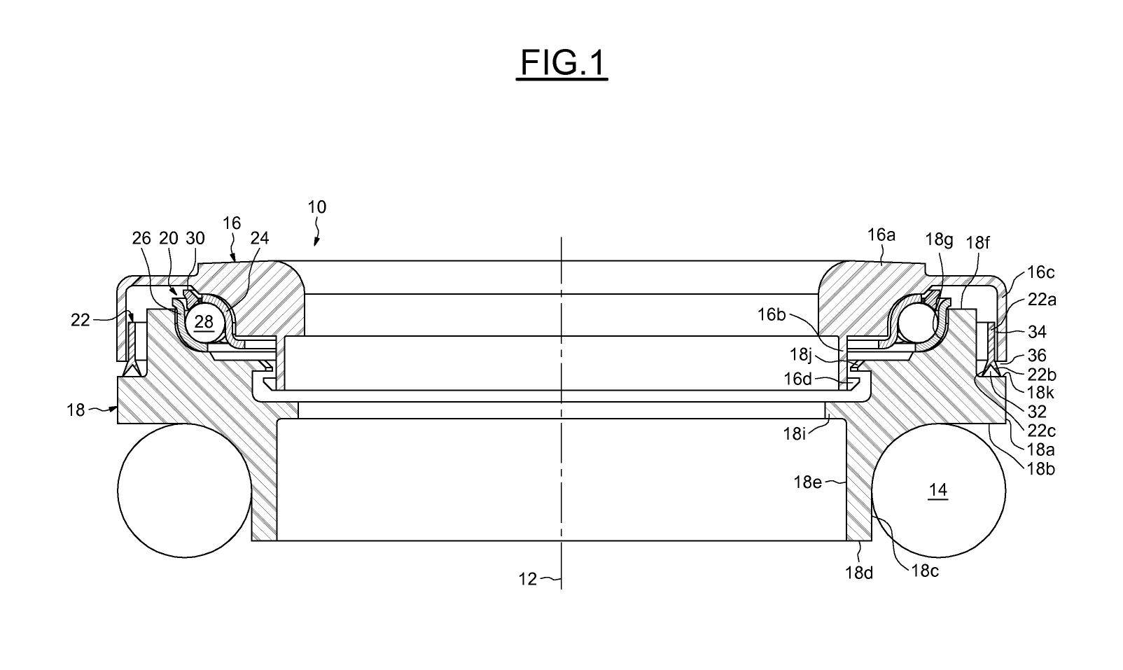

FIG. 1 is a view in axial section of an axial thrust bearing device according to a first example of the invention, and

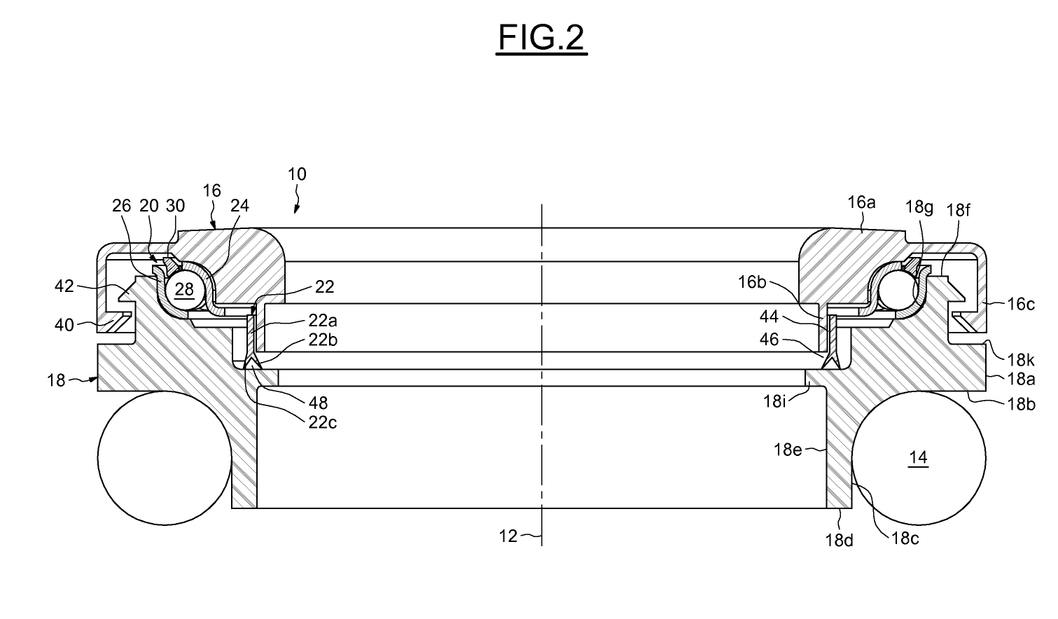

FIG. 2 is a view in axial section of an axial thrust bearing device according to a second example of the invention.

As illustrated on FIG. 1, an example of axial thrust bearing device 10, with an axis 12, is installed between a top retainer seat (not shown) suitable of resting, directly or indirectly, in an element of a chassis of the motor vehicle, and a suspension spring 14. The device 10 is disposed around a damper rod (not shown) extending on the axis 12, the spring 14 being installed around said rod.

The device 10 comprises a top bearing cover 16, a bottom support cover 18, a rolling bearing 20 axially disposed between the covers, and a sealing ring 22 radially mounted between said covers to reduce any ingress of foreign matter.

The top bearing cover 16 may consist in one part, for example from plastic material, such as polyamide PA 6.6 which may or may not be reinforced with glass fibers. The top bearing cover 16 comprises a top radial portion 16a designed to be in contact with the top retainer seat, an annular internal axial skirt 16b of small thickness and of small diameter, and an annular external axial skirt 16c of small thickness and of large diameter radially surrounding the internal skirt 16b. The skirts 16b, 16c extend axially downwards from the radial portion 16a.

The rolling bearing 20 is entirely located radially between the skirts 16b, 16c of the top bearing cover 16. The rolling bearing 20 comprises a top ring 24 and a bottom ring 26, between which is mounted a row of rolling elements 28, which in this case are balls. The rolling bearing 20 also comprises a cage 30 between the rings so as to maintain an even circumferential spacing between the rolling elements 28.

The top ring 24 and the bottom ring 26 are made of a thin metal sheet, which has been stamped or rolled so as to define toroidal tracks or raceways for the rolling elements 28 between the two rings. The top ring 24 is in contact with a bottom surface of the radial portion 16a of the top bearing cover 16. The bottom ring 26 is in contact with a top surface of the bottom support cover 18. The concave external surface of the top ring 24 forms the track or raceway for the rolling elements 28, the concave internal surface of the bottom ring 26 forming the track or raceway for said rolling elements.

The bottom support cover 18 may consist in one part, for example from plastic material, such as polyamide PA 6.6 which may or may not be reinforced with glass fibers. The bottom support cover 18 comprises a cylindrical axial external surface 18a of small axial dimension from the bottom end of which extends inwards an annular radial surface 18b which is prolonged towards the inside and downwards by a rounded surface then by a cylindrical axial surface 18c. The axial surface 18c makes it possible to centre the spring 14 whereas the radial surface 18b provides a bearing surface for said spring.

From the bottom end of the axial surface 18c, a radial annular bottom surface 18d extends towards the inside, prolonged from an edge of small diameter axially upward by a stepped axial surface forming the bore 18e of the bottom support cover 18.

From the top end of the axial external surface 18a, the bottom support cover 18 also comprises an annular axial skirt 18f extending axially towards the radial portion 16a of the top bearing cover 16. The skirt 18f radially surrounds the bottom ring 26. The skirt 16c of the top bearing cover 16 radially surrounds the skirt 18f. The top end of the skirt 18f is prolonged towards the inside by a surface 18h in contact with the bottom ring 26 and of a form complementing said ring.

The bottom support cover 18 further comprises an annular radial rib 18i provided on the bore 18e at the vicinity of its top end. The rib 18i is directed radially towards the inside and is axially positioned below the axial skirt 16b of the top bearing cover 16 so as to delimit with said skirt a narrow axial annular passage. In other words, the rib 18i is located slightly away from the axial skirt 16b to form an internal labyrinth sealing portion.

The bottom support cover 18 also comprises, at the top end of the stepped bore 18e, an annular radial rib 18j extending towards the inside in the direction of the internal skirt 16b of the top bearing cover 16. The rib 18j is disposed radially between the top ring 24 of the rolling bearing and the axial skirt 16b. Said rib is disposed axially above hooks 16d arranged on the external surface of the skirt 16b of the cover 16 at its bottom end. The hooks 16d extend radially outwards towards the bottom support cover 18 and are axially spaced apart from the rib 18j. The hooks 16d are advantageously spaced relative to one another in the circumferential direction. Alternatively, a hook continuous in the circumferential direction may be provided on the external surface of the skirt 16b.

The rib 18j has a bottom radial surface able to interfere with hooks 16d. The rib 18j is designed to interact with the hooks 16d in order to prevent a separation of the bottom support cover 18 from the top bearing cover 16 before the device 10 is installed in the top part of the suspension strut. To this end, the external diameter of the hooks 16d is greater than the inner diameter of the rib 18j so that a diametral interference can exist between the covers 16, 18. The rib 18j therefore forms an axial retaining means disposed on the bottom support cover 18 and adapted to interact with complementary axial retaining means of the top bearing cover 16, i.e. the hooks 16d, in order to axially retain said covers one relative to another before the installation of the device 10. Before its installation, the device 10 constitutes a unitary assembly that can be handled, transported, and installed without risk of coming apart.

Otherwise, the hooks 16d and the rib 18j form narrow passageways in order to prevent the intrusion of foreign matter radially between the internal skirt 16b of the top bearing cover 16 and the stepped bore 18e of the bottom support cover 18.

In order to limit the ingress of foreign matter inside the external annular radial space delimited by the skirt 18f of the cover 18 and the external skirt 16c of the cover 16, the sealing ring 22 is disposed radially therebetween.

The sealing ring 22 is made in one part and may be advantageously made from plastic material by moulding, for example in polyamide (PA). Alternatively, the sealing ring 22 may also be made from metal. The sealing ring 22 has an annular shape and is resting axially on an annular radial surface 18k of the bottom support cover 18 delimited between the rib 18f and the axial external surface 18a. The radial surface 18k extends radially inwards the top end of the external surface 18a, its edge of small diameter being connected to the bottom end of the external surface of the skirt 18f.

The sealing ring 22 comprises an annular axial portion 22a having a bottom end from which there issue an annular outer friction lip 22b extending outwards and an annular inner friction lip 22c situated radially on the side of the external surface of the skirt 18f of the cover 18. The outer and inner lips 22b, 22c extend radially inwards in the direction of the radial surface 18k of the cover 18 and come into friction contact with said surface. The contact between said lips 22b, 22c and the cover 18 is axial. The outer and inner lips 22b, 22c are adapted to block the foreign particles and thus prevent them from intruding between the sealing ring 22 and the bottom support cover 18.

The outer lip 22b extends obliquely outwards from the bottom end of the axial portion 22a and the inner lip 22c extends obliquely inwards from said bottom end. The outer lip 22b is axially offset towards the outside relative to the inner lip 22c. In the illustrated embodiment, the tip of the outer lip 22b is radially disposed in an axial plane containing the skirt 16c of the top bearing cover 16. The outer and inner lips 22b, 22c are symmetric relative to one another with regard to an axial plane containing the axial portion 22a of the sealing ring 22.

The thickness of the outer and inner lips 22b, 22c reduces from the axial portion 22a towards their free ends or tips which bear against the radial surface 18k of the bottom support cover 18. In this embodiment, the lips 22b, 22c have in cross-section a triangular shape. An annular linear contact exists between each tip of the lips 22b, 22c and the radial surface 18k. With such a contact, when wear appears, there is less friction than with a rounded portion for the tip of the outer and inner lips 22b, 22c. Besides, even if the pressing force of the lips 22b, 22c is low, the surface pressure of each lip on the bottom support cover 18 increases. Hence, even with a small interference between said lips and the cover 18, intrusion of foreign matter can be effectively prevented.

The outer and inner lips 22b, 22c form an upside-down V and delimit radially an annular chamber 32. The chamber 32 is delimited axially by the said lips and by the axially-facing portion of the radial surface 18k of the cover 18. The chamber 32 may advantageously be filled with a lubricant, such as grease, for instance a hydrophobic grease, said lubricant forming a sealed rim. Thus, the overall sealing of the ring 22 is increased.

Otherwise, the external surface of the axial portion 22a of the sealing ring 22 delimits, with the internal surface or bore of the axial skirt 16c of the cover 16, an annular radial labyrinth sealing zone 34 via annular radial narrow passageway. In other words, the sealing ring 22 is located radially slightly away from the bore of the skirt 16c to form a labyrinth sealing portion. For instance, the radial gap between the bore of the external skirt 16c and the external surface of the axial portion 22a may be less than 1 mm, and for instance comprised between 0.2 and 0.4 mm.

Besides, the external surface of the outer lip 22b of the sealing ring delimits, with the free bottom end of the skirt 16c, another annular labyrinth sealing zone 36 extending obliquely outwards and downwards the radial labyrinth sealing zone 34. The labyrinth sealing zone 36 is also formed via annular narrow passageway.

The labyrinth sealing zone 36 located axially between the bottom end of the skirt 16c of the cover 16 and the external surface of the outer lip 22b and the labyrinth sealing zone 34 disposed radially between the bore of said skirt and the axial portion 22a of the sealing ring prevent the foreign matter from intruding inwards between said sealing ring and the top bearing cover 16. In fact, the labyrinth sealing zone 36 forms a first labyrinth sealing portion extending along a first direction and prolonged by the labyrinth sealing zone 34 constituting a second labyrinth sealing portion extending along a second direction distinct from said first direction. Thus, even if foreign matter pass through the first labyrinth sealing zone 36, the second labyrinth sealing zone 34 limits their intrusion inward.

In a mounted position of the device 10 as illustrated on FIG. 1, the axial contact between the friction lips 22b, 22c and the radial surface 18k is the only contact of the seal ring 22 with the bottom support cover 18. The sealing ring 22 is resting axially on the cover 18. In this mounted position, there is no contact between the seal ring 22 and the top bearing cover 16. Therefore, the friction contacts between the sealing ring 22 and said covers are limited. Besides, with the lips 22b and 22c, the friction contact with the bottom support cover 18 is reduced with respect to a sealing ring having a plane radial surface bearing against said cover.

The sealing ring 22 is moveable freely relative to the covers 16, 18 in the axial, radial and circumferential directions. In case of an axial deformation of the bottom support cover 18 due to the axial loads of the spring 14, the sealing function of the ring 22 is maintained since it is moveable axially freely. Under the effect of the radial loads of said spring, the sealing ring 22 may be into radial contact with the bottom support cover 18 and/or with the top bearing cover 16. However, the contact between the ring 22 and said covers does not generate a friction torque since the ring is only resting on the bottom support cover 18. Besides, this contact is linear and not circumferential.

The embodiment shown on FIG. 2, in which identical parts are given identical references, differs from the first embodiment in that the sealing ring 22 has a reduced diameter in order to be disposed radially between the internal skirt 16b of the top bearing cover 16 and the stepped bore 18e of the bottom support cover 18, and in that axial retaining means provided to axially retain said covers relative to one another are disposed on the external skirts 16c, 18f of said covers.

The top bearing cover 16 comprises, arranged on the internal bore of the skirt 16c at its bottom end, an annular radial rib 40 extending radially inwards and able to diametrically interfere with an annular rib 42 arranged on the external surface of the skirt 18f of the bottom cover 18 and extending radially outwards. The rib 40 is positioned axially below the rib 42 and spaced apart from said rib. The ribs 40, 42 form narrow passageways in order to prevent the intrusion of foreing matter radially between the skirts 16c, 18f.

The sealing ring 22 is resting axially on the top radial surface of the rib 18i of the bottom support cover 18. In this embodiment, the friction lip 22b is the inner lip of the sealing ring 22 and the friction lip 22c is the outer lip. These lips bear against the top radial surface of the rib 18i. The disposition of the internal surface or bore of the axial portion 22a of the sealing ring 22 relative to the external surface of the skirt 16b of the cover 16 is similar to the one previously described between the external surface of the axial portion 22a and the bore of axial skirt 16c in the first embodiment. Thus, an annular radial labyrinth sealing zone 44 via annular radial narrow passageway is formed between the bore of the sealing ring 22 and the external surface of the skirt 16b.

Similarly to the first embodiment, an additional labyrinth sealing zone 46 which extends obliquely inwards and downwards said labyrinth sealing zone 44 is formed between the free end of the skirt 16b and the internal surface of the lip 22b. An annular chamber 48 is also delimited axially by said lips. The sealing ring 22 is also able to freely move in axial, radial and circumferential directions relative to the covers 16, 18.

It should be noted that the embodiments illustrated and described were given merely by way of a non-limiting indicatives examples and that modifications and variations are possible within the scope of the invention. Thus, the invention applies not only to an angular contact ball bearing with a single row of balls but also to other types of rolling bearing, for example bearings having four points contacts and/or with double rows of balls, or with at least three rows of balls. It is easily understood that it could also be possible to use bearing with other types of rolling members such as rollers.

Otherwise, in both disclosed embodiments, the sealing rings forming sleeves are each provided with two friction sealing lips. Alternatively, it may also be possible to foresee sealing rings having a different number of friction lips, for example one lip which may extend purely radially, or three lips or more.

In another embodiment, it could also be possible to disposed two sealing rings radially between the bottom support cover and the top bearing cover, the first radially between the external skirt of the top bearing cover and the external skirt of the bottom support cover, and the second radially between the internal skirt of said top bearing cover and the stepped bore of the bottom support cover. Alternatively, it may also be possible to foresee a sealing ring surrounding the external skirt of the top bearing cover and bearing axially against the bottom support cover. In another embodiment, the sealing ring may be disposed inside the bores of the bottom support cover and of the top bearing cover while bearing against the radial rib provided on the stepped bore of said bottom support cover.

1. Axial thrust bearing device, in particular for the suspension strut of a motor vehicle, comprising:
a bottom support cover
a top bearing cover,
a rolling bearing axially disposed between said covers, and
at least a sealing ring freely movable in axial direction relative to the bottom support cover and to the support bearing cover, the sealing ring being adapted to reduce any ingress of foreign matter between said covers, and wherein
the sealing ring includes at least one friction lip bearing against the bottom support cover, the ring delimiting with the top bearing cover at least a labyrinth sealing zone.

2. Device according to claim 1, wherein the sealing ring delimits with the top bearing cover an annular radial labyrinth sealing zone.

3. Device according to claim 2, wherein an axial portion of the sealing ring from which is issued the friction lip delimits with a skirt of the top bearing cover the annular radial labyrinth sealing zone.

4. Device according to claim 2, wherein an additional labyrinth sealing zone extending the radial labyrinth sealing zone is delimited between the sealing ring and the top bearing cover.

5. Device according to claim 4, wherein the friction lip of the sealing ring delimits with a skirt of the top bearing cover the additional labyrinth sealing zone.

6. Device according to claim 1, wherein the sealing ring is resting axially on the bottom support cover.

7. Device according to claim 1, wherein the sealing ring is radially disposed between the bottom support cover and the top bearing cover.

8. Device according to claim 1, wherein the sealing ring delimits with an external skirt of the top bearing cover the labyrinth sealing zone.

9. Device according to claim 1, wherein the sealing ring delimits with an internal skirt of the top bearing cover the labyrinth sealing zone.

10. Device according to claim 1, wherein the friction lip bears against a radial surface of the bottom support cover.

11. Device according to claim 1, wherein the thickness of the tip of the friction lip is smaller than the one of an axial portion from which is issued said friction lip.

12. Device according to claim 1, wherein the friction lip has in cross-section a triangular shape.

13. Device according to claim 1, wherein the sealing ring comprises at least two friction lips delimiting an annular chamber capable of being filled with lubricant.

14. Device according to claim 1, wherein the sealing ring is freely movable in radial direction relative to the bottom support cover and to the top bearing cover.

15. Suspension strut for a motor vehicle including a damper and an axial thrust bearing device, the axial thrust bearing device comprising:
a bottom support cover,
a top bearing cover,
a rolling bearing axially disposed between said covers, and
at least a sealing ring freely movable in axial direction relative to the bottom support cover and to the support bearing cover, the sealing ring being adapted to reduce any ingress of foreign matter between said covers, and wherein
the sealing ring includes at least one friction lip bearing against the bottom support cover, the ring delimiting with the top bearing cover at least a labyrinth sealing zone.
